(19) United States
(12) Patent Application Publication
(10) Pub. No.: US 2018/0337538 A1
(43) Pub. Date: Nov. 22, 2018

(54) MULTI-PURPOSE CADDY STATION

(71) Applicant: BLUE RHINO GLOBAL SOURCING, INC., Liberty, MO (US)

(72) Inventors: Marc Zemel, Melville, NY (US); Robert Sukiel, Commack, NY (US)

(21) Appl. No.: 15/981,366

(22) Filed: May 16, 2018

Related U.S. Application Data
(60) Provisional application No. 62/506,665, filed on May 16, 2017.

(51) Int. Cl. H02J 7/00; H01R 25/00; A47F 10/06; A47G 21/16

(52) U.S. Cl. CPC H02J 7/0027; H02J 7/0042; A47G 21/16; A47F 10/06; H01R 25/006

(57) ABSTRACT

A multi-purpose caddy station to assist with charging of a portable device, specifically to assist with charging of portable devices having a rechargeable battery. The multi-purpose caddy station can be used while dining at food establishments like a restaurant, or bar. The multi-purpose caddy station includes a body portion and a charging portion, and the charging portion includes at least one output connector and at least one power connector.

### CROSS-REFERENCE TO RELATED APPLICATION

This application claims the benefit of and priority to U.S. Provisional Application No. 62/506,665 filed on May 16, 2017, the entire contents of which is incorporated herein by reference.

### BACKGROUND

### Technical Field

The present disclosure relates to a battery charging station, more specifically, to a charging station which transfers AC or DC power into devices having a rechargeable battery. The charging station can be used or placed in food serving establishments and can transfer power into a portable device by way of a USB port.

### Description of Related Art

Most food establishments do not provide battery charging stations, for portable devices. Devices like mobile phones, tablets, smart computers, and the like are used daily at restaurants, bars and other food establishments either for communication purposes or for leisure activities. When dining or socializing at a bar or restaurant, many patrons are seen using their mobile devices, either taking a picture of their food and posting it on social media applications, browsing online, or making a phone call, all which are activities that may reduce the mobile device's battery life. Consequently, it is a highly valued service to provide multi-purpose caddy stations that allow customers to easily and conveniently maintain or charge their mobile device's battery. For example, when patrons do not have to worry about their phone losing all of its battery life towards the end of the night, they may stay longer at the establishment which in turn provides more business for the food and drink establishment while enhancing the customer's dining and social experience.

Additionally, it is important that food and drink establishments keep up with the technology trends and continue to satisfy the customer's needs. Accordingly, it is desirable to incorporate a portable, compact, multi-purpose charging station for portable mobile devices, which may also include a design that may blend and match with the establishment décor.

Therefore, a need exists for more efficient ways and devices that can provide battery charging features to customers at restaurants, bars, and other food establishments.

### SUMMARY

Existing challenges associated with the foregoing, as well as other challenges, are overcome by methods for transferring power into a portable device at food serving establishments via systems, and apparatuses that operate in accordance with the methods.

According to an example embodiment herein, a caddy, having a body portion, including a first, a second, and a third opening, the openings defining a first, a second, and a third pocket, wherein one of the openings is substantially wider than the two remaining openings; and a charging portion, including a power connector and at least one output connector; where the body portion and the charging portion are configured to be connected; and where the body portion further includes an opening having a V-shaped cross-sectional profile defining a pocket entry access, the pocket entry access enables lateral access into a selected pocket.

In one example, the caddy includes pockets defining connecting walls therebetween, the walls further including a C-shaped cross-sectional profile channel.

In another example, the caddy includes a V-shaped profile opening extending vertically along a side of the body portion and tapering from one opening to a bottom wall.

According to one example, the charging portion comprises a lower surface including at least one non-slipping component connected therefrom.

Yet in another example the V-shaped profile opening defines a contour channel with dull edges.

Still in another example, the body portion and the charging portion are configured to share a common wall or are integrally formed.

According to another example embodiment herein, a caddy kit comprising a housing portion, including three substantially rectangular pockets, and defining a lower portion and a bottom portion, wherein the three substantially rectangular pockets define walls therebetween, the walls including a C-shaped cross-sectional profile channel which connects one pocket to another pocket; a power connection hub; the power connection hub including a power-in connector and a power-out connector.

In examples the caddy kit includes a power wire; wherein the power out connector is a plurality of female USB connectors, each one of the plurality of female USB connectors configured to receive a male USB connector, the power-in connector is configured to receive a connector connected to the power wire.

In one example, the caddy kit includes a power connection hub connected to the lower portion of the housing portion.

### BRIEF DESCRIPTION OF THE DRAWINGS

The accompanying drawings, which are incorporated in and constitute a part of this specification, illustrate embodiments of the present disclosure and, together with a general description of the present disclosure given above, and the detailed description of the embodiments given below, serve to explain the principles of the present disclosure.

FIG. 1 is a perspective view illustrating a multi-purpose caddy station in accordance with the present disclosure;

FIG. 2 is a front elevational view the multi-purpose caddy station of FIG. 1;

FIG. 3 is a rear elevational view of the multi-purpose caddy station of FIG. 1;

FIG. 4 is a is an enlarged view of a selected area of FIG. 3;

FIG. 5 is a bottom plan view of the multi-purpose caddy station of FIG. 1;

FIG. 6 is a bottom perspective view of the multi-purpose caddy station of FIG. 1.

### DETAILED DESCRIPTION

Detailed embodiments of the present device are disclosed herein. It is to be understood, however, that the disclosed embodiments are merely exemplary of the device as a whole, which may be embodied in various and alternative forms. The figures are not necessarily to scale, and some figures may be configured to show the details of a particular component. Therefore, specific structural and functional details disclosed herein are not to be interpreted as limiting, but merely as a representative basis for the claims and for teaching one skilled in the art to practice the present invention.

Various embodiments of the presently disclosed multi-purpose caddy station, and methods of using the same will now be described in detail with reference to the drawings wherein like references numerals identify similar or identical elements.

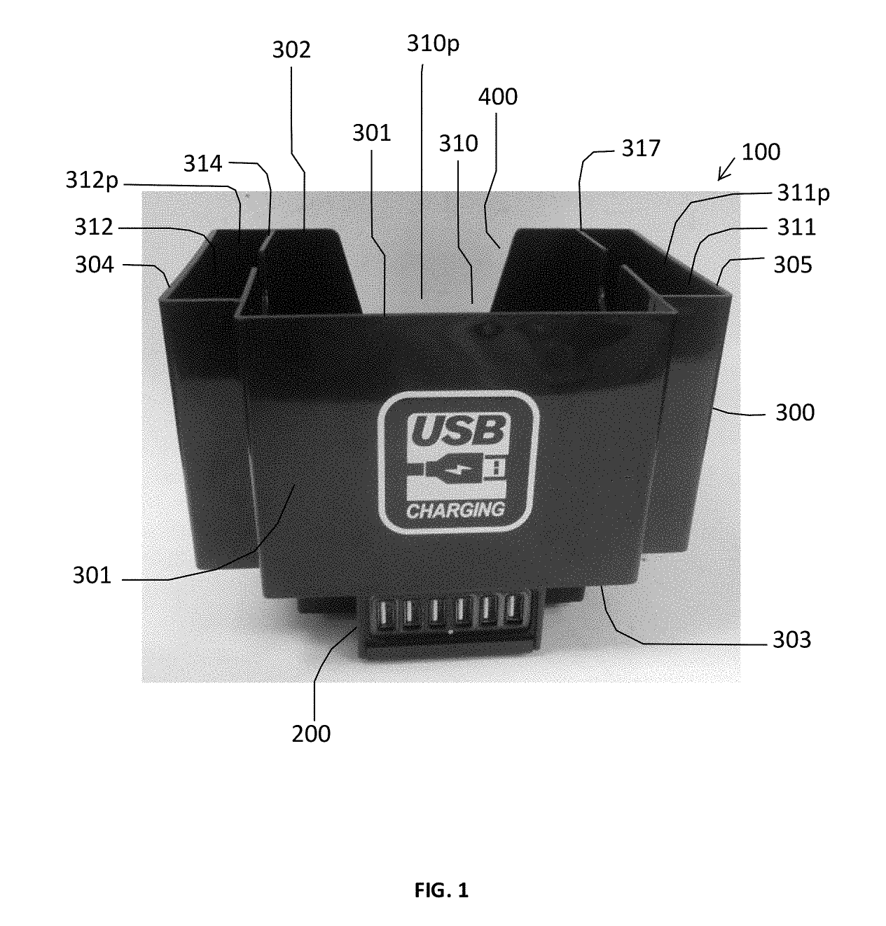

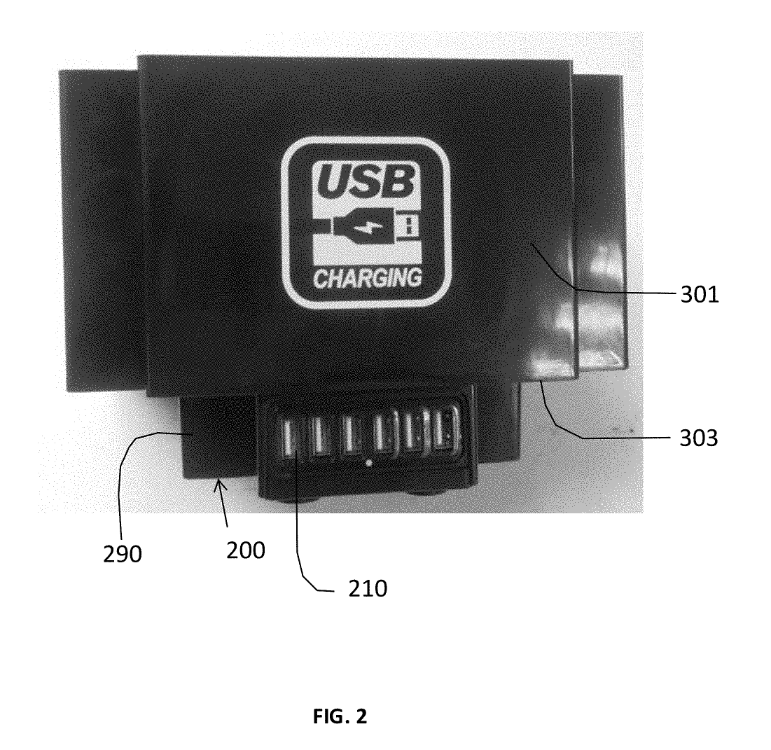

Referring now in detail to the drawing figures and in particular initially to FIGS. 1 and 2, a multi-purpose caddy station 100 is presented. Caddy station 100 includes a power hub or charging portion 200 and a body portion 300. In embodiments, caddy station's 100 shape may resemble the shape of a bar napkin holder or be configured to hold napkins, straws, condiments, drink accompaniments and the like. The body portion 300 may include an opening 310 of any shape and additional adjacent openings thereof. For example, body portion 300 may include an opening 310 configured to receive a set of napkins and may further include an opening 311 configured to receive and/or dispense a straw or any other item that requires easy access for use by the establishment. In embodiments, body portion 300 may further include a third opening 312 configured to receive a portable device like a mobile device or computer. In embodiments, opening 312 may be configured to receive drink ornaments like a drink umbrella or a drink stirrer.

Still referring to FIGS. 1 and 2, body portion 300 may include a front wall 301, a back wall 302, a base wall 303, and at least one side wall 304, all which may be substantially flat. In embodiments, body portion 300 may include an additional wall 305 opposed to wall 304. Walls 301, 302, 304, and 305 may define the shape of body portion 300 along a base wall 303.

In embodiments, caddy station 100 may include separation walls to define receiving pocket/pockets therein. In embodiments, caddy station 100 may include separation walls 314 and 317, and along with walls 301-305 may define pockets configured to receive an object into caddy station 100. More specifically, wall 304, wall 314, a portion of wall 301, a portion of wall 302, and a portion of wall 303 define a pocket 312p; wall 305, wall 317, a portion of wall 301, a portion of wall 302, and a portion of wall 303 define a pocket 311p; wall 314, wall 317, a portion of wall 301, a portion of wall 302, and a portion of wall 303 define a pocket 310p.

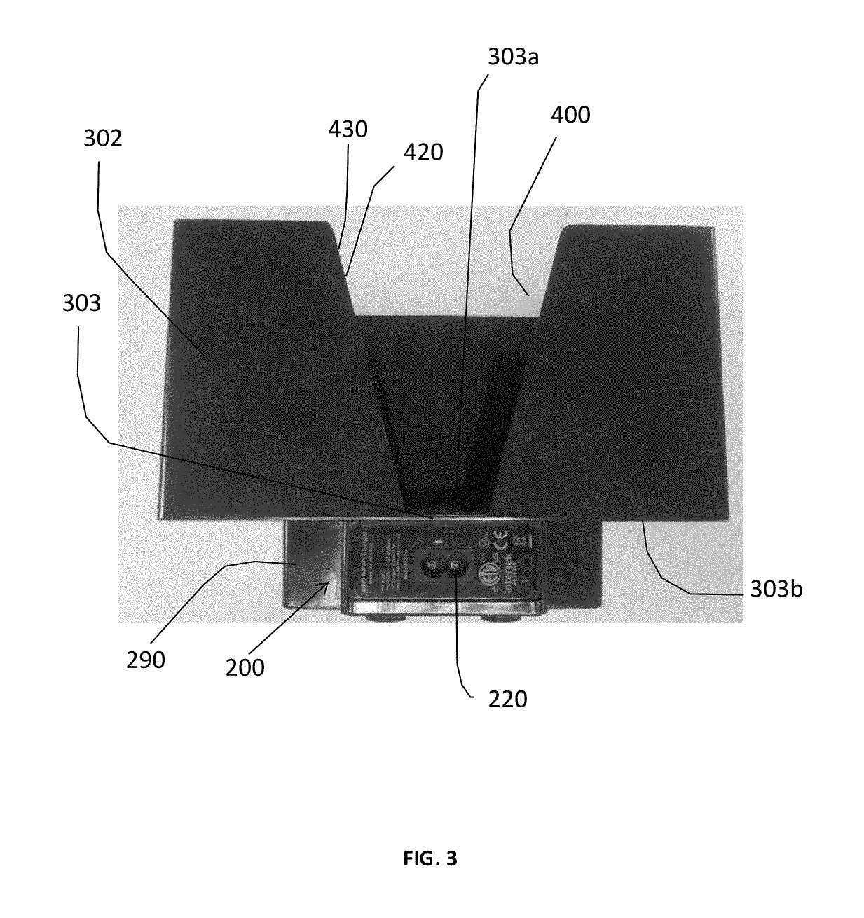

Openings 310-312 may have a substantially rectangular shape and may define the shape of pockets 310p-312p, and be configured to receive an object therein for easy access by employees or consumers. For example, pocket 310p may be configured to receive a set of napkins. More specifically, as shown in FIG. 3, wall 303 includes an inner surface 303a and an outer surface 303b, and along with opening 310 can be configured to receive a set of stacked napkins of the same shape thereof. While in use, a user can place a set of napkins onto inner surface 303a passing through opening 310 and further access a napkin from the set of napkins by opening 310 or by the way of a pocket entry access or release channel 400. Release channel 400 will be described further below.

Still referring to FIGS. 1-2, caddy station 100 may include a charging portion 200 which includes a housing 290, which can be provided with multiple and various power input interfaces to connect with various power sources—both AC and DC sources including U.S. and foreign electric-pin sockets of varying designs, and a USB interface. Charging portion 200 is mounted onto caddy station 100 and may transmit energy and/or energy signals to a computing device via a connection port of wireless signals, e.g., WI-FI®, BLUETOOTH®, LTE®, USB®, NFC and other known configurations or protocols. In embodiments, charging portion 200 is mounted to wall 303 onto a portion of outer surface 303b. Charging portion 200 may include at least one port or output connector 210 to transfer power from a wall socket by the way of caddy station 100. In embodiments, output connector 210 may be a USB port or an NFC charging interface. In different embodiments, the caddy station 100 may also be provided with various power output interfaces to connect with electronic devices having varying connection interfaces, such as USB, micro-USB, mini-USB, Apple Lightning™, Apple 30-pin, or the like. In embodiments, caddy station 100 includes multiple output connectors 210, each capable of attachment to a different connection interface, thereby eliminating the need for separate adapter pieces. Alternatively, the caddy station 100 may utilize interchangeable power output connectors, such as with the addition of removable, modular adapter pieces. For example, caddy station 100 may include an output connector 210 of the USB type and a power connector 220. In embodiments, caddy station 100 includes multiple connection ports.

In embodiments, caddy station 100 may synchronize application and USB power save periods for a wide variety of applications. Applications may, for example, comprise wireless network modules or other application modules with a sleep mode. In embodiments, caddy station 100 may be battery powered and may include on-board memory, battery, display and an audio port. Moreover, appropriate interface or supporting electronics for each port may also be included, but need not be described herein. In certain embodiments, multiple USB ports may be provided to provide customers with the ability to charge mobile phones and other devices that are chargeable through a USB port.

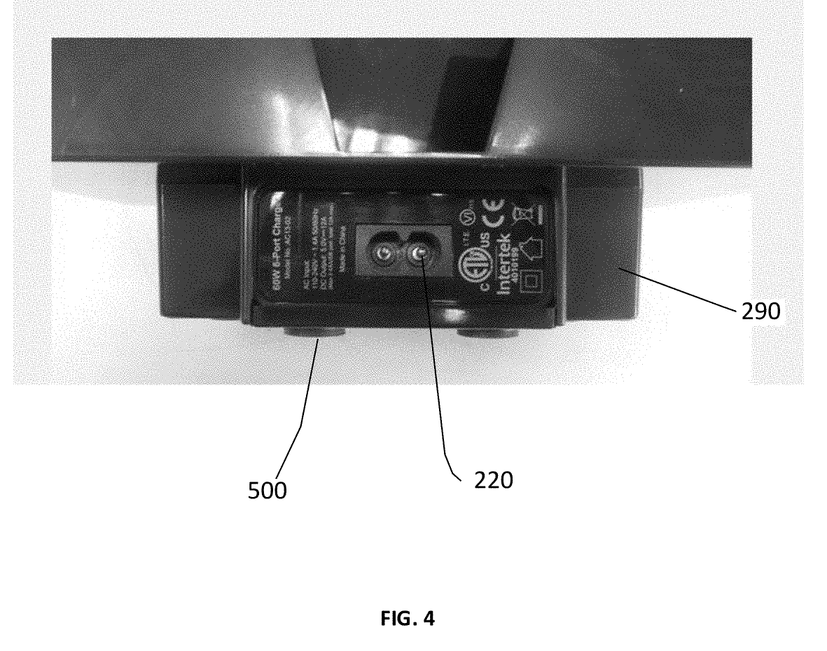

Referring to FIGS. 3-4, caddy station 100 may include an opening or release channel 400 to enable alternative access to opening 310. More specifically, back wall 302 of caddy station 100 may include at least a first section 420 adjacent to opening 310 and tapering towards bottom wall 303. Release channel 400 may enable a user to isolate and pull therethrough a towel/napkin away from a plurality of towels/napkins. As mentioned above a set of napkins/towels can be placed onto surface 303a, and release channel 400 can allow lateral access through wall 302 and enable a user to pull a napkin/towel from the set of napkins away from caddy station 100.

Release channel 400 may include but is not limited to a tapered, substantially V-shaped profile. In some embodiments, the release channel may originate at the opening 310 tapering from a relative wide opening at the first section into a relative narrow or shallow opening towards bottom wall 303. Release channel 400 extends longitudinally tapering along wall 302 defining a channel contour 430. Additionally, is contemplated that channel contour 430 may have different shapes, such as wave, zig-zag and arced. Further, channel contour 430 of release channel 400 may be configured, in part or absolute, to include sharp and/or round edges or a combination of both.

Channel contour 430 of release channel 400 may be reduced or increase friction forces between the towel/napkin and caddy station 100. For example, when pulling a towel away from the plurality of towels/napkins, it may be desired to construct release channel 400 where channel contour 430 may include rounded edges to reduce friction forces.

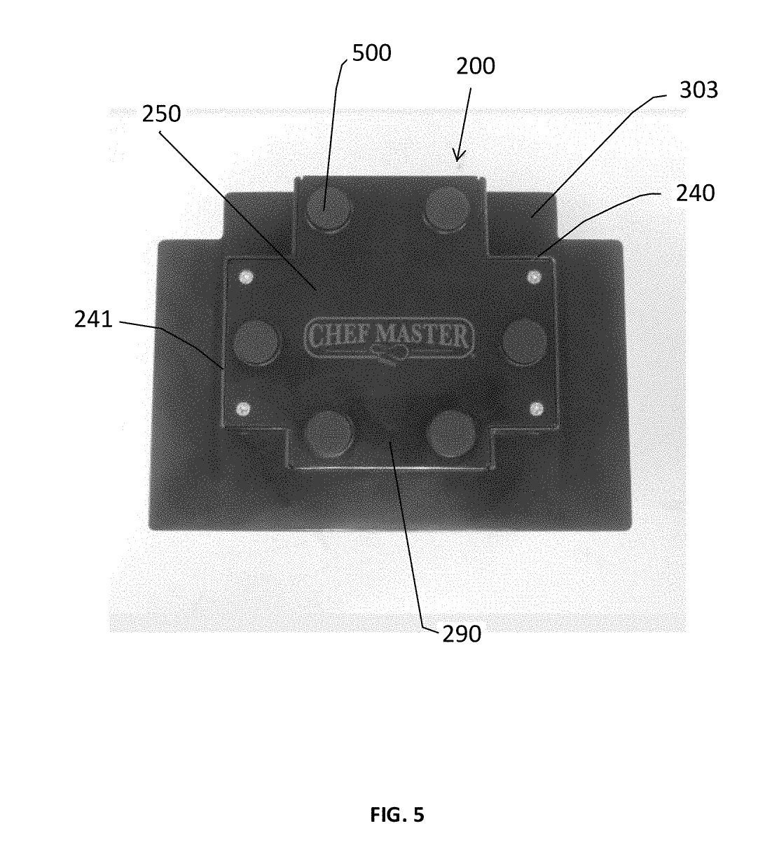

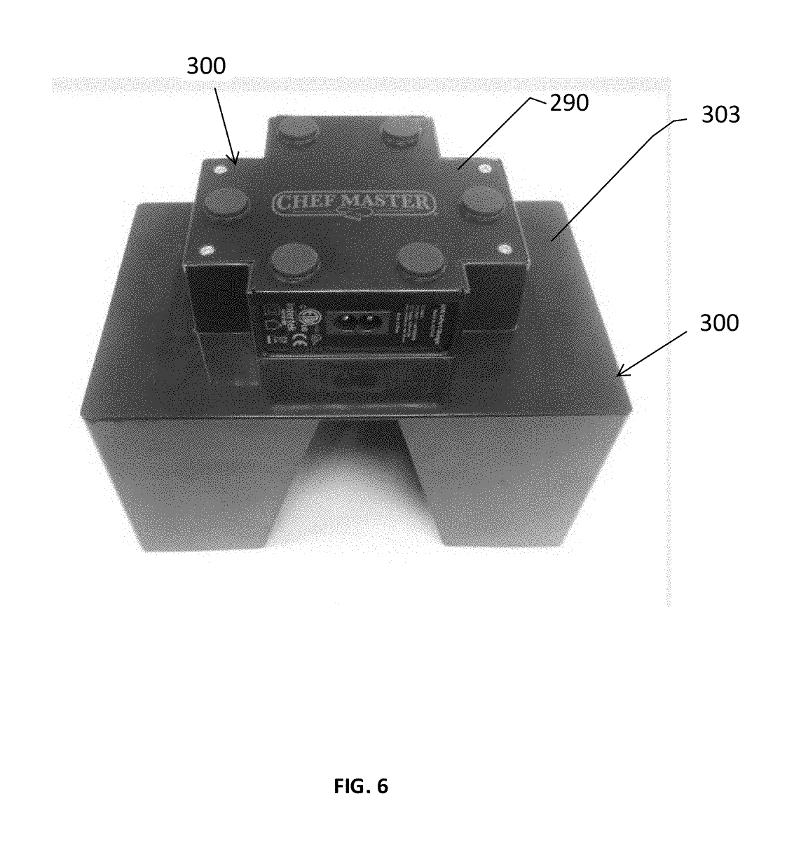

With reference to FIG. 5-6, caddy 100 may include a series of supports or non-slipping components 500. For example, when placing caddy 100 onto a flat surface non-slipping component 500 may reduce sliding of caddy 100 or may reduce the probability of damaging the surface in contact with the caddy 100. The non-slipping components 500 can be connected along surface 303b and configured to provide support and stability to the caddy 100 when placed onto a surface.

In embodiments and still with reference to FIGS. 5-6, charging portion 200 may include an opening 240 (not shown). More specifically, housing 290 includes an opening 240 configured to receive and house electronic components associated with the above-mentioned port 210 and power connector 220. In embodiments, caddy 100 may include a door panel 250 with a similar shape to mate the shape of opening 240 and when mounted onto door panel 250 may partially or fully cover opening 240. In embodiments, door panel 250 can be mounted and coupled to charging portion 200 or wall 303 by the use of well-known in the art connecting means, for example, panel 250 can include through holes to enable fastening of panel 250 by the way of at least one screw. In embodiments, panel 250 can be glued to a contour lip 241 of charging portion 200.

Note that while the charging portion 200 could be mounted onto body portion 300, in embodiments, it may be desired to build caddy 100 as one piece. For example, caddy 100 may be the result of a manufacturing process like extruding, injection molding, blow molding, or the like. Thus, housing 290 and body portion 300 may be a unitary part provided with complementary joint portions.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A caddy, comprising:
a body portion, including a first, a second, and a third opening, the openings defining a first, a second, and a third pocket, wherein one of the openings is substantially wider than the two remaining openings; and
a charging portion, including a power connector and at least one output connector; wherein the body portion and the charging portion are configured to be connected; and
wherein the body portion further includes an opening having a V-shaped cross-sectional profile defining a pocket entry access, the pocket entry access enables lateral access into a selected pocket.

2. The caddy of claim 1, wherein the pockets define connecting walls therebetween, the walls further including a C-shaped cross-sectional profile channel.

3. The caddy of claim 1, wherein the V-shaped profile extends vertically along a side of the body portion and tapering from one opening to a bottom wall.

4. The caddy of claim 1, wherein the charging portion comprises a lower surface including at least one non-slipping component connected therefrom.

5. The caddy of claim 1, wherein the V-shaped profile defines a contour channel with dull edges.

6. The caddy of claim 1, wherein the body portion and the charging portion are configured to share a common wall or are integrally formed.

7. A caddy kit comprising:
a housing portion, including three substantially rectangular pockets, and defining a lower portion and a bottom portion, wherein the three substantially rectangular pockets define walls therebetween, the walls including a C-shaped cross-sectional profile channel which connects one pocket to another pocket;
a power connection hub; the power connection hub including a power-in connector and a power-out connector; and
a power wire;
wherein the power out connector is a plurality of female USB connectors, each one of the plurality of female USB connectors configured to receive a male USB connector, the power-in connector is configured to receive a connector connected to the power wire; and
wherein the power connection hub is connected to the lower portion of the housing portion.
